(19) United States
(12) Patent Application Publication
(10) Pub. No.: US 2009/0300100 A1
(43) Pub. Date: Dec. 3, 2009

(54) AUGMENTED REALITY PLATFORM AND METHOD USING LOGO RECOGNITION

(76) Inventor: Carl Johan Freer, Westport, CT (US)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/172,803

(22) Filed: Jul. 14, 2008

Related U.S. Application Data
(60) Provisional application No. 61/057,471, filed on May 30, 2008.

(51) Int. Cl. G06F 15/16; G06K 9/68

(52) U.S. Cl. 709/203; 382/218

(57) ABSTRACT

An augmented reality platform is provided which interacts between a mobile device and a server via a communication network. The augmented reality platform includes an image recognition application located on the mobile device which receives a live, real-time image and converts the image into coordinates, and a client application located on the mobile device which transmits a data packet including the coordinates. A server application provided on the server receives the data packet from the client application, identifies a logo included in the live, real-time image, and sends content or a link thereto to the mobile device in accordance with the logo. The client application on the mobile device processes the content or the link thereto and forms an augmented reality image on a display of the mobile device based on the live, real-time image and the content.

### CROSS-REFERENCE TO RELATED APPLICATION

This application claims priority under 35 U.S.C. §119(e) of U.S. provisional patent application Ser. No. 61/057,471 filed May 30, 2008, which is incorporated by reference herein.

### FIELD OF THE INVENTION

The present invention relates generally to a method and system for implementing augmented reality techniques when viewing logos using a mobile device.

The present invention also relates to an augmented reality software platform designed to deliver dynamic and customized augmented reality content to mobile devices.

The present invention also relates to a distributed, augmented reality software platform designed to transport and support augmented reality content to mobile devices.

### BACKGROUND OF THE INVENTION

Augmented reality is an environment that includes both virtual reality and real-world elements, is interactive in real-time, and may be three-dimensional.

There are numerous known applications of augmented reality. However, none of the conventional applications link augmented reality to the recognition of a logo. That is, none of the conventional applications links the virtual reality element of augmented reality to the recognition of a logo in the real-world element of augmented reality.

Logos are generally considered symbols associated with particular goods and/or services, and may be trademarks of the entity providing the goods and/or services. For example, one well known logo is the pair of arches readily associated with the McDonald's restaurant chain.

Often, people are in close proximity to logos and associate the logo with the particular goods and/or services. Today, many people carry mobile devices, such as personal digital assistant (PDA) devices and cellular telephones (e.g., cellular camera phones). Such electronic devices typically include a camera or other imaging component capable of obtaining images to be displayed on a display component. Thus, today, people can obtain images of logos using their mobile devices.

However, current mobile devices are not capable of recognizing a logo in an image obtained by the device, and are not capable of responding to the recognition of a logo.

### SUMMARY OF THE INVENTION

The present invention provides a new and improved method and system for enabling a mobile device to apply augmented reality techniques.

According to one aspect of the present invention, a method and system for implementing augmented reality is provided wherein the virtual reality element is linked to the recognition of a logo in the real-world element.

According to another aspect of the present invention, a distributed augmented reality software platform is provided which is capable of delivering dynamic and/or customized augmented reality content to mobile devices.

More specifically, an augmented reality platform in accordance with the invention generally includes software and hardware components capable of live image capture (at the mobile device), establishing connections between the mobile device and other servers and network components via one or more communications networks, transmitting communications or signals between the mobile device and the server and network components, retrieving data from databases resident on the mobile device or at the server or from other databases remote from the mobile device, cataloging data about content to be provided to the mobile device for the augmented reality experience and establishing and maintaining a library of content for use in augmenting reality using the mobile device. With such structure, the invention provides a complete mobile delivery platform and can be created to function on all active mobile device formats (regardless of operating system).

A platform in accordance with the invention is modeled using a distributed computing/data storage model, i.e., the computing and data storage is performed both at the mobile device and at other remote components connected via a communications network with the mobile device. As such, the platform in accordance with the invention differs from current augmented reality platforms which are typically self-contained within the mobile device, i.e., the mobile device itself includes hardware and software components which obtain images and then perform real-time pattern matching (whether of markers or other indicia contained in the images) to ascertain content to be displayed in combination with live images, and retrieve the content from a memory of the mobile device. These current platforms typically comprise a single application transmitted to and stored on the mobile device without any involvement of a remote hardware and/or software component during the pattern matching and content retrieval stages.

In a specific implementation, an augmented reality platform in accordance with the invention provides for real-time live pattern recognition of logos using mobile devices involving one or more remote network components. Ideally, the live, real-time image obtained by the imaging component of the mobile device would constitute only the logo. A marker indicating the presence of the logo may be inserted in the logo. When a logo in an obtained image has been recognized, or identified, the mobile device sends a signal derived from the logo to a main server. The main server determines appropriate content to provide to the mobile device based on the signal derived from the logo, i.e., based on the logo.

An important advantage of the invention is that the main server can customize the content being provided to each mobile device, i.e., to the user thereof, and thereby provide dynamic content to the mobile devices. The content may be customized based on the region in which the mobile device is situated, i.e., country, state, town, zip code, longitude and latitude, based on a user profile established and maintained by each user, based on information about the user obtained from the user and/or from sources other than the user, based on the user's location, based on the location of the image being obtained by the mobile device, and combinations of the foregoing. Moreover, the platform can be arranged to mix dynamic content provided by the main server with mobile phone applications such as games, GPS and or GPS similar software, language tools, maps and other phone-embedded software.

Another advantage of the involvement of a main server remotely situated to the mobile devices, and which facilitates the pattern matching and content retrieval, is that it easily allows for the introduction of new logos to a library or database of logos on an ongoing basis so that the programming on the mobile devices does not require updates whenever a new logo is created and it is sought to provide content to mobile devices which obtain images including this new logo.

Yet another advantage is that the computing power necessary to perform pattern matching may be provided by the main server which has virtually no limitations on size, whereas performing pattern matching on the mobile device is limited in speed in view of the size of the mobile device's hardware components.

### BRIEF DESCRIPTION OF THE DRAWINGS

The invention, together with further advantages thereof, may best be understood by reference to the following description taken in conjunction with the accompanying drawings, wherein like reference numerals identify like elements, and wherein:

FIG. 1 is a schematic showing the primary components of an augmented reality platform in accordance with the invention.

FIG. 2 is a schematic showing a registration process to enable a user of a mobile device to use the augmented reality platform in accordance with the invention.

### DETAILED DESCRIPTION OF THE INVENTION

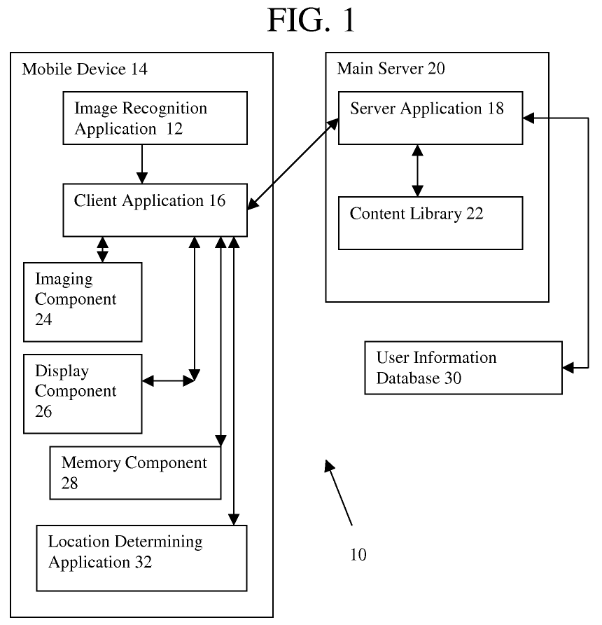

Referring to the accompanying drawings wherein like reference numerals refer to the same or similar elements, FIG. 1 shows primary components of the augmented reality platform which interacts with logos in accordance with the invention, designated generally as 10. The primary components of the platform 10 include an image recognition application 12 located on the user's mobile device 14, a client application 16 located and running on the user's mobile device 14, a server application 18 located and running on a (main) server 20, and a content library 22 which contains the content or links thereto being provided to the mobile device 14. All of the primary components of the platform 10 interact with one another, e.g., via a communications network, such as the Internet, when the interacting components are not co-located, i.e., one component is situated on the mobile device 14 and another is at a site remote from the mobile device 14 such as at the main server 20.

The image recognition application 12 is coupled to the imaging component 24 of the mobile device 14, i.e., its camera, and generally comprises software embodied on computer-readable media which analyzes images being imaged by the imaging component 24 (which may be an image of only a logo or an image containing a logo) and interprets this image into coordinates which are sent to the client application 16. The images are not necessarily stored by the mobile device 14, but rather, the images are displayed live, in real-time on the display component 26 of the mobile device 14.

To aid in the interpretation of the images into coordinates, a marker may be formed in combination with the logo and is related to, indicative of or provides information about the logo. As such, the coordinates may be generated by analyzing the marker. The marker may be a frame marker forming a frame around the logo.

The client application 16 may be considered the central hub of software on the mobile device 14. It receives the coordinates from the image recognition application 12 and transmits that information (e.g. via XML) to the server application 18. After the server application 18 locates the appropriate content or a link thereto, based on the coordinates, and sends the content to the mobile device 14, the client application 16 processes that content or link thereto and forms a display on the display component 26 of the mobile device 14 based on the live image and the content.

The server application 18 may be located on a set of servers interconnected by the Internet. The client application 16 contacts the server application 18 and passes a query string, containing the coordinates derived from the live, real-time image being imaged by the mobile device 14. The server application 18 parses that string, identifies the live image as a legitimate image (for which content or a link thereto could be provided), queries the content library 22, retrieves the proper content or link thereto from the content library 22 and then encrypts the content or link thereto and directs it to the client application 16.

Additionally, the server application 18 may be designed to log the activity, track and create activity reports and maintain communication with all active client applications 16. That is, the server application 18 can handle query strings from multiple client applications 16.

The content library 22 may be located on a separate set of servers than the server application 18, or possibly on the same server or set of servers. The illustrated embodiment shows the main server 20 including both the server application 18 and the content library 22 but this arrangement is not limiting and indeed, it is envisioned that the content library 22 may be distributed over several servers or other network components different than the main server 20.

The content library 22 stores all augmented reality content and links thereto that are to be delivered to client applications 16. The content library 22 receives signals from the server application 18 in the form of a request for content responsive to coordinates derived by the image recognition application 12 from analysis of a live, real-time image. When it receives the request, the content library 22 first authenticates the request as a valid request, verifies that the server application 18 requesting the information is entitled to receive a response, then retrieves the appropriate content or link thereto and delivers that content to the server application 18.

To use the platform 10, the user's mobile device 14 would be provided with the client application 16 which may be pre-installed on the mobile device 14, i.e., prior to delivery to the user, or the user could download the client application 16 via an SMS message, or comparable protocol for delivery, sent from the server application 16.

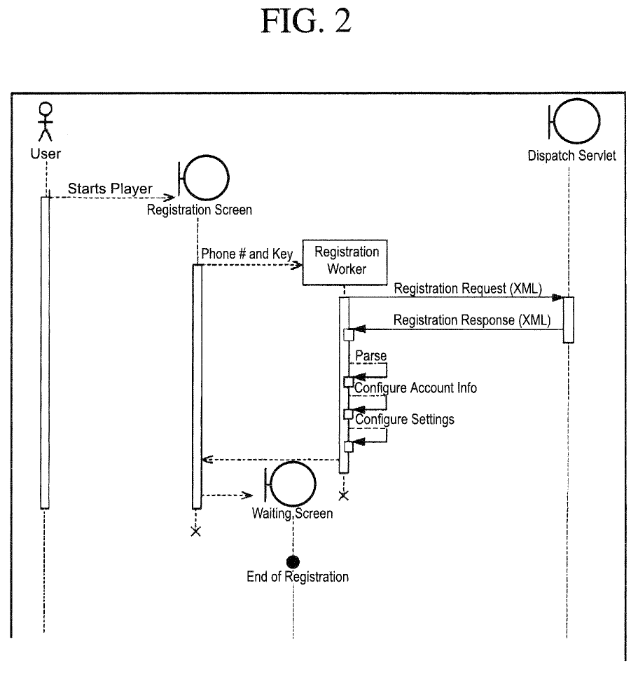

Registration to use the augmented reality platform 10 is preferably required and FIG. 2 shows a registration process diagram which would be the first interaction between the user and the client application 16, once installation on the mobile device 14 is complete. The user starts the client application 16 and is presented with a registration screen. The user enters their phone number of the mobile device 14 and a key or password indicating their authorization to use the mobile device 14. A registration worker generates and sends a registration request to a dispatch servlet via a communications network which returns a registration response. The registration worker parses the response, configures account information and settings and then indicates when the registration is complete. During the registration process, the user may be presented with a waiting screen.

After registration, the user is able to run the client application 16 as a resident application on the mobile device 14. This entails selecting the application, then entering the “run” mode and pointing the imaging component 24 of the mobile device 14 towards a logo (the mobile device 14 does not have to store the image of the logo and in fact does not store the images, unless the user takes action to also store the images). The image recognition application 12 analyzes the live image, which may be entirely the logo, and converts it into a series of coordinates. The client application 16 receives the coordinates from the image recognition algorithm 12 and encrypts the coordinates and prepares them for transmission to the server 20 running the server application 18, preferably in the form of a data packet or series of packets. After the client application 16 has transmitted the data packet, the client application 16 waits for a response from the server application 18.

After the client application 16 receives a response from the server application 18, also preferably in the form of a data packet, the client application 16 works through a series of commands to decode the data packet. First, the client application 16 verifies that the data packet is authentic, e.g., by matching a URL returned from the server 20 against the URL specified within the client application 16, and if the URLs match, the client application 16 decrypts the data packet using a key stored within the client application 16.

The data packet contains several data fields in it including, for example, a link to a URL having content, new data key, and voucher information. The client application 16 is arranged to store the new key, retrieve the content via the link provided in the data packet and store the voucher.

The client application 16 also retrieves the content (from the provided link to a URL) and displays the content within the display component 26 of the mobile device 14 by merging the content with the live, real-time image being displayed on the display component 26. The content, if an image, may be superimposed on the live image.

To ensure that the client application 16 is the latest version thereof, the client application 16 may be arranged to connect to the server 20 running the server application 18 based on a pre-determined timeframe and perform an update process. This process may be any known application update process and generally comprises a query from the client application 16 to the server 20 to ascertain whether the client application 16 is the latest version thereof and if not, a transmission from the server 20 to the mobile device 14 of the updates or upgrades.

The server application 18 may receive input from the client application 16 via XML interface.

The server application 18 performs a number of basic interactions with the client application 16, including a registration process (see FIG. 2), a registration response process, an update check process and an update response. With respect to the update processes, as noted above, the client application 16 is configured to respond to the server application 18 based on a pre-determined time frame which may be on an incremental basis. This increment is set within the client application 16.

The primary function of the server application 18 is to provide a response to the client application 16 in the form of content or a link thereto. The response is based on the coordinates in the data packet transmitted from the mobile devices 14. Specifically, the server application 18 may be arranged to decrypt the information string sent from the client application 16 using the key provided with the data, parse the response into appropriate data delimited datasets, and query one or more local or remote databases to authenticate whether the mobile device 14 has been properly registered (i.e., includes a source phone number, key returned). If the server application 18 determines that the mobile device 14 has been properly registered, then it proceeds to interpret the data coordinates and determines if they possess a valid pattern (of a logo). If so, the coordinates are placed into an appropriate data string and a query is generated and transmitted to the content library 22 for a match of coordinates. If an appropriate data coordinate match is found by the content library 22 (indicating that content library 22 can associate appropriate content or a link thereto with the logo from which the data coordinates have been derived), the server application 18 receives the appropriate content or a link to the appropriate content (usually the latter).

The link to the appropriate content, voucher information, a new encryption key and the current key are encrypted into a new data packet and returned by the server application 18 to the client application 16 of the mobile device 14 as an XML string. The server application 18 then logs the action undertaken in a database, i.e., it updates a device record with the new key, and the date and time of last contact, it updates an advertiser record with a new hit count (the advertiser being the entity whose goods and/or services are associated with the logo or a related or contractual party thereto), it updates the content record with transaction information and it also updates a server log with the transaction. The server he—application 18 then returns to a ready or waiting state for next connection attempt from a mobile device 14, i.e., it waits for receipt of another data packet from a registered mobile device 14 which might contain data coordinates derived from an image containing a logo.

The content library 22 is the main repository for all content and links disseminated by the augmented reality platform 10. The content library 22 has two main functions, namely to receive information from the server application 18 and return the appropriate content or link thereto, and to receive new content from a content development tool. The content library 22 contains the main content library record format (Content UID, dates and times at which the content may be provided, an identification of the advertisers providing the content, links to content, parameters for providing the content relative to information about the users, such as age and gender). The content library 22 also contains a content log for each content record which includes revision history (ContentUID, dates and times of the revisions, an identification of the advertisers, an identification of the operators, actions undertaken and software keys). The content development tool enables new logos to be associated with content and links and incorporated into the platform 10.

By associating information about the users with content and links in the content library 22, information about the user of each mobile device 14 is thus considered when determining appropriate content to provide to the mobile device 14. This information may be stored in the mobile device 14 and/or in a database (user information database 30) associated with or accessible by the main server 20 and is retrieved by the main server when it is requesting content from the content library 22. The main server 20 would therefore provide information about the user to the content library 22 and receive one of a plurality of different content or links to content depending on the user information. Each logo could therefore cause different content to be provided to the mobile device 14 depending on particular characteristics of the user, e.g., the user's age, gender, etc.

Alternatively, the content library could provide a plurality of content and links thereto based solely on the logo and the main server 20 applies the user information to determine which content or link thereto should be provided to the mobile device 14.

Instead of or in addition to considering information about the user when determining appropriate content to provide to the user's mobile device 14, it is possible to consider the location of the mobile device 14. A significant number of mobile devices include a location determining application for determining the location thereof, whether using a GPS-based system or another comparable system. In this case, the client application 16 may be coupled to such a location determining application 32 and provide information about the location of the mobile device 14 in the data packet being transmitted to the server application 18 to enable the server application 18 to determine appropriate content to provide based on the coordinates and the information about the location of the mobile device 14, which may also be customized to the capabilities of the phone.

The foregoing structure enables methods for a user's mobile device 14 to interact with logos, interacting by receiving content based on the logo. The user can therefore view a logo on a building or signpost, image the logo and obtain content based on the image, with the content being displayed on the same display component 26 as the live, real-time image of the logo. For example, if the user images a restaurant's logo, the user might be provided with content such as a menu of the restaurant, an advertisement for food served at the restaurant and/or a coupon for use at the restaurant, all of which could be superimposed over the logo on the display component 26 of the mobile device 14.

Such a method would entail obtaining a live, real-time image using the imaging component 24 of the mobile device 14, determining whether the image contains a logo and when the image is determined to contain a logo, providing content to the mobile device 14 based on the logo. The mobile device 14 may be positioned so that only the logo is present in the image, i.e., the image and the logo are the same, or so that the image contains a logo, i.e., the logo and part of its surrounding area is present in the image.

The determination of whether the image contains a logo may entail providing the mobile device 14 with a processor and computer-readable media embodying a computer program for analyzing images obtained using the mobile device to derive coordinates therefrom (the image recognition application 12), operatively running the computer program via a processor when a live image is obtained by the imaging component 24 of the mobile device 14 to thereby derive coordinates, and directing the coordinates to a remote location (via the client application 16). The remote location includes computer-readable media embodying a computer program for analyzing the coordinates to determine whether they indicate the presence of one of a predetermined set of logos in the image (the sever application 18 at the main server 20). Content and links thereto may be stored in association with the predetermined set of logos (at the content library 22) and when a determination is made that an image contains one of the predetermined set of logos, the content or a link to content associated with that logo is retrieved (from the content library 22). The retrieved content or link to content is then provided to the mobile device 14, i.e., via a communications network.

More generally, the determination of whether the image contains a logo entails generating a signal at the mobile device 14 derived from the image potentially containing the logo (possibly a marker alongside or around the logo), transmitting the signal via a communications unit of the mobile device 14 to the main server 20, and determining at the main server 20 whether the signal derived from the image contains a logo (via analysis of the coordinates derived from the image at the server application 18). When the main server 20 determines that the signal derived from the image contains a logo, it obtains content or a link thereto associated with that logo (from the content library 22) and the retrieved content or link thereto is provided to the mobile device 14. The content provided to the mobile device may be a link to a URL, in which case, the mobile device 14 processes the URL to retrieve content from the URL.

To customize the content to each user of a mobile device 14, information about the user of mobile devices is stored and the content is then provided to the mobile device 14 based on the information about the user. The information may be stored in the mobile device 14 and/or in a database accessible to or associated with the main server 20.

In view of the foregoing, the invention also contemplates a mobile device 14 capable of implementing augmented reality techniques which would include an imaging component 24 for obtaining images, a display component 26 for displaying live, real-time images being obtained by the imaging component 24, an image recognition application 12 as described above and a client application 16 coupled to the image recognition application 12 and the display component 26. The functions and capabilities of the client application 16 are described above. The mobile device 14 could also include a memory component 28 including information about a user of the mobile device which could be entered therein by a user interface of the mobile device 14. The client application 16 could then transmit information about the user from the memory component 28 to the remote server 20 with the coordinates derived from the live images being obtained by the imaging component 24. The mobile device 14 optionally includes a location determining application 32 for determining the location of the mobile device 14. In this embodiment, the client application 16 may transmit information about the location of the mobile device 14 to the server 20 with the coordinates.

It is to be understood that the present invention is not limited to the embodiments described above, but include any and all embodiments with in the scope of the following claims. While the invention has been described above with respect to specific apparatus and specific implementations, it should be clear that various modifications and alterations can be made, and various features of one embodiment can be included in other embodiments, within the scope of the present invention.

1. A distributed augmented reality platform which interacts between a mobile device and a server, comprising:
an image recognition application located on the mobile device which receives a live, real-time image imaged by an imaging component of the mobile device, and which converts the image into coordinates;
a client application located on the mobile device which receives the coordinates from the image recognition application, and which transmits a data packet or packets including the coordinates;
a server application located on the server which receives the transmission of the data packet from the client application, determines content to be provided to the mobile device based on the coordinates, and sends the content or a link thereto to the mobile device.

2. The distributed augmented reality platform of claim 1, further comprising a content library which is coupled to the server application and which stores content and/or links associated with logos, and wherein the client application on the mobile device is adapted to process the content or the link thereto and to form an augmented reality image on a display of the mobile device based on the live, real-time image and the content.

3. The distributed augmented reality platform of claim 2, wherein the server application is adapted to recognize a logo included in the image imaged by the imaging component of the mobile device based on the coordinates included in the data packet received from the client application, and wherein the server application retrieves the content or the link thereto to be provided to the mobile device from the content library based on the recognized logo.

4. The distributed augmented reality platform of claim 1, wherein the augmented reality image comprises the content superimposed on the live, real-time image.

5. The distributed augmented reality platform of claim 1, further comprising a memory which stores information about a user of the mobile device, wherein the server application obtains the information about the user from the memory and determines the content or the link thereto to be provided to the mobile device based on the information about the user as well as the coordinates included in the data packet received from the client application.

6. The distributed augmented reality platform of claim 1, further comprising a location determining application which determines a location of the mobile device, wherein the server application obtains the location of the mobile device from the location determining application and determines the content or the link thereto to be provided to the mobile device based on the obtained location as well as the coordinates included in the data packet received from the client application.

7. A method of providing an augmented reality experience on a mobile device, comprising:
obtaining a live, real-time image using an imaging component of the mobile device;
identifying a logo contained in the image;
providing the mobile device with content or a link thereto based on the identified logo.

8. The method of claim 7, wherein the mobile device derives coordinates of the live, real-time image and transmits the derived coordinates to a server in a data packet, and wherein the server identifies the logo contained in the image based on the coordinates included in the data packet.

9. The method of claim 8, wherein the server is coupled to a content library which stores content and/or links associated with logos, and the server retrieves the content or the link thereto to be provided to the mobile device from the content library based on the identified logo.

10. The method of claim 7, wherein the mobile device displays an augmented reality image comprising the content superimposed on the live, real-time image.

11. The method of claim 8, further comprising storing information about a user of the mobile device, and determining the content or the link thereto to be provided to the mobile device based on the information about the user as well as the coordinates included in the data packet.

12. The method of claim 8, further comprising determining a location of the mobile device, and determining the content or the link thereto to be provided to the mobile device based on the determined location as well as the coordinates included in the data packet.

13. The method of claim 7, wherein the logo contained in the live, real-time image is identified by identifying a marker formed in combination with the logo.

14. The method of claim 13, wherein the marker comprises a frame formed around the logo.

15. The method of claim 11, wherein the content comprises an advertisement for goods or services associated with the logo.

16. A mobile device comprising:
an imaging component which obtains a live, real-time image, and converts the image into coordinates;
a transmitting unit which transmits a data packet including the coordinates;
a receiving unit which receives content or a link thereto which is determined based on the coordinates and potentially other data; and
a display which displays an image based on the content.

17. The mobile device of claim 16, wherein the image displayed by the display comprises an augmented reality image in which the content is superimposed on the live, real-time image obtained by the imaging component.

18. The mobile device of claim 16, further comprising a memory storing information about a user of the mobile device, wherein the content or the link thereto received by the receiving unit is determined based on the information about the user as well as the coordinates included in the data packet.

19. The mobile device of claim 16, further comprising a location determining device which determines a location of the mobile device, wherein the content or the link thereto received by the receiving unit is determined based on the obtained location as well as the coordinates included in the data packet.

20. The mobile device of claim 16, wherein the coordinates of the data packet include the coordinates of a logo.
